(19) United States
(12) Patent Application Publication
(10) Pub. No.: US 2020/0118119 A1
(43) Pub. Date: Apr. 16, 2020

(54) Currency Agnostic Conversion And Deployment System

(71) Applicant: Treis Blockchain LLC, Greer, SC (US)

(72) Inventors: David Pence, Greenville, SC (US); Michael Bolick, Greer, SC (US); Senter Smith, Greenville, SC (US)

(73) Assignee: Treis Blockchain LLC, Greer, SC (US)

(21) Appl. No.: 16/653,893

(22) Filed: Oct. 15, 2019

Related U.S. Application Data
(60) Provisional application No. 62/744,807, filed on Oct. 12, 2018.

(51) Int. Cl. G06Q 20/36; G06Q 20/06; G06Q 20/10; G06Q 20/38; G06Q 40/02

(52) U.S. Cl. CPC G06Q 20/3678; G06Q 20/0658; G06Q 40/02; G06Q 20/381; G06Q 20/108

(57) ABSTRACT

This system is directed to a currency agnostic conversion and deployment system comprising: an immutable digital ledger; and, a cloud service having a set of cloud service computer readable instructions for: receiving a fiat currency deposit request, associating the fiat currency deposit request with an account holder associated with the remote computer device, and, crediting a cloud service user account with a value represented by the fiat currency deposit request, storing the fiat currency deposit request, the unique reference number, the location, date and time of the remote computer device, a cloud service user account credit on the immutable digital ledger, transmitting to the remote computer device a confirmation representing that the cloud service user account was credited, and, receiving a digital purchase request, debiting the cloud service user account according to the digital purchase request, and crediting a service operator cloud service account according to the digital purchase request.

### RELATED APPLICATIONS

This application claims priority on U.S. Provisional Patent Application 62/744,807 titled Currency Agnostic Conversion and Deployment System filed Oct. 12, 2019 that is incorporated herein by reference.

### BACKGROUND OF THE INVENTION

### 1) Field of the Invention

This system is a decentralized system directed to interconnectivity and interoperability of conversions and deployment of fiat currency and cryptocurrency using digitized, distributed, secure and immutable ledgers to provide and record commercial transactions.

### 2) Description of the Related Art

Recently, cryptocurrencies have grown in popularity. Generally, cryptocurrency is a digital currency that designed to operate as a platform for exchange. Cryptography is utilized to secure and verify transactions as well as to control the creation of new units of value (e.g. a particular cryptocurrency). Basically, cryptocurrencies are limited rows in a database that cannot be changed unless specific conditions are met.

One challenge with cryptocurrencies is that converting fiat currencies to cryptocurrency is a slow, non-standardized process and can be complicated. One traditional method to convert fiat currency into cryptocurrency is to buy with cash. This method can involve giving cash to someone who is already in a cryptocurrency exchange. This, of course, requires you to know someone in a cryptocurrency exchange and convince them to assist you with the transaction. There are also decentralized sites allowing strangers to connect so that such a transaction can occur. Disadvantages include long processing times in the exchange process, very high transaction fees and having to trust strangers. There are also Blockchain ATMs allowing a user to use a physical location (e.g. Blockchain ATM) to buy blockchain currency using fiat currency and have it sent to a blockchain wallet. The Blockchain ATM can also be used to sell blockchain currency to allow fiat currency to be withdrawn. Blockchain ATMs are currently not widely available and generally have very high transaction fees. Another method is to register for an account with a cryptocurrency exchange, enable 2-factor authentication, verify the account, deposit fiat currency, transfer funds into your account, and buy a cryptocurrency. This process can take days or even weeks.

In typical commercial transaction infrastructure for fiat currency and cryptocurrency, there can be financial institutions, block producers, Blockchain ATMs, customers, and vendors. With so many parties involved, consensus on which fiat currency to use can be dictated by regulations, laws, or other governmental or regulatory entities. Further, certain payment methods such as credit card and Blockchain ATM can carry a fee between 1.5% to over 10.5%. Further, there can be additional fees for merchant services provider. The merchant services provider acts as a middleman between the merchant and the creditor. A fee is charged for processing credit card payments, collecting interchange fees, and managing the transfer of fiat funds between the merchant's bank and the creditor bank. Further, when operating with different currencies, currency conversion has to occur, there is no one standard worldwide currency.

The same fee structure does not exist with blockchain currency so that these fees can be reduced or eliminated. However, it would be advantageous to have a simpler and easier system for acquiring. managing and using blockchain currencies and converting blockchain currencies between fiat currencies.

There have been some attempts to automate the buying and selling of digital currency such as United States Patent Application Publication 20150220928, but such attempts do not consider fiat currencies and are limited to the cyber media. There has also been an attempt to link physical commodities (i.e. diamonds) with cryptocurrency tokens such as in United States Published Patent Application 20190164152, but such systems are tied to narrow physical commodities (e.g. diamonds).

### BRIEF DESCRIPTION OF THE SEVERAL VIEWS OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is schematic of aspects of the system;

FIG. 2 is schematic of aspects of the system;

FIG. 3 is a flowchart of aspects of the system; and

FIG. 4 is a flowchart of aspects of the system.

### DETAILED DESCRIPTION OF THE INVENTION

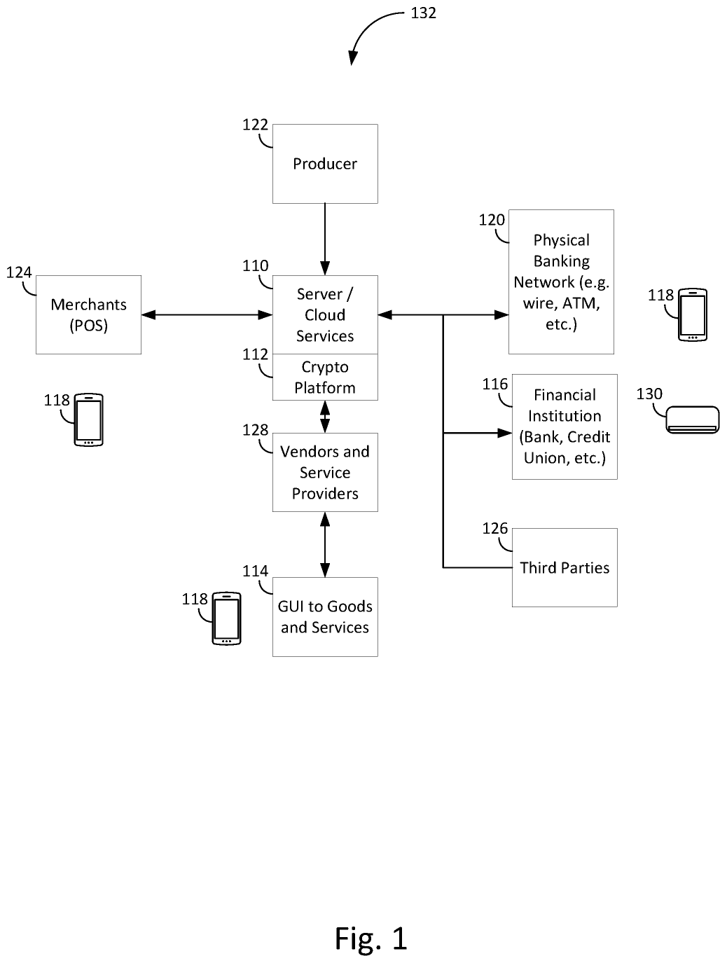

With reference to the drawings, the invention will now be described in more detail. Referring to FIG. 1, a server or cloud service 110 includes computer readable instructions that, when executed by one or more processors, performs the functionality described herein. The cloud service can access a crypto platform such as a blockchain platform to provide an immutable history of data to provide for a secure mathematically verifiable record of the content of data the cloud service at a point in time. In one case, the crypto platform is EOS from eos.io.

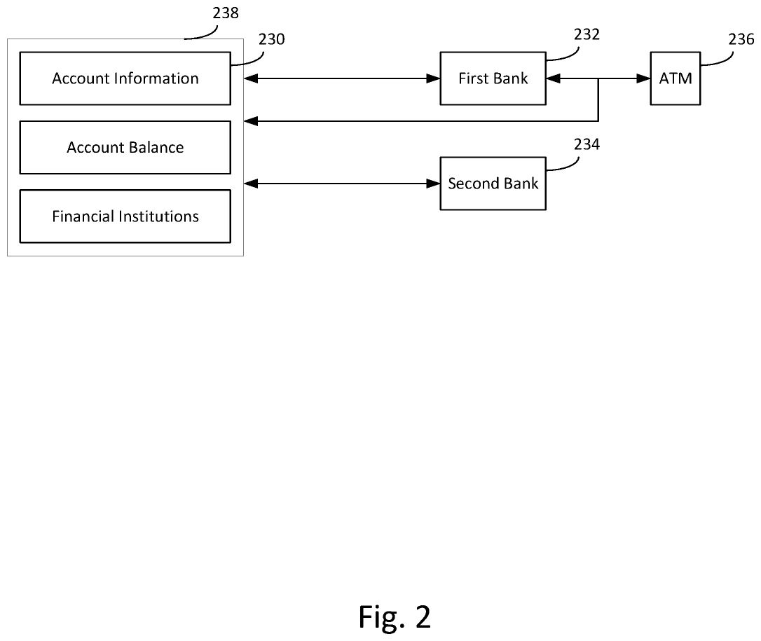

The cloud service can include account information 230 (FIG. 2) at a financial institution 116 for one or more accounts with accounting information known to the cloud service, but not necessary to each user of the system. Multiple financial institutions can be in communications with the cloud services. For example, a first bank 232 (FIG. 2) and a second bank 234 (FIG. 2) can be independently in communications with the could services allowing information to be transmitted between the financial institutions and the cloud services independently.

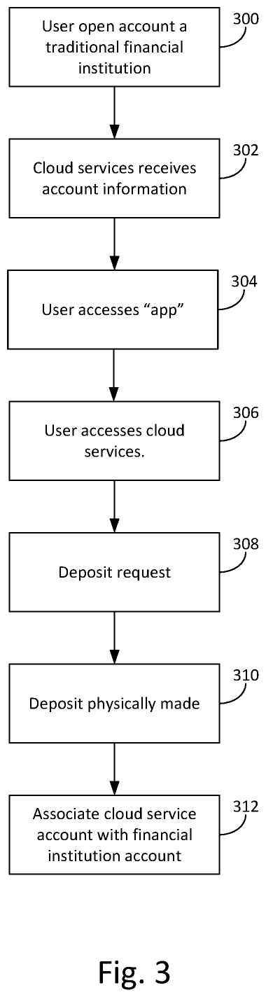

Referring to FIG. 3, fiat currency can be deposited in the financial institution at 300, the service can note that the fiat currency is placed on the account of that financial service. The cloud service can receive the user account information at 302 and can create or update a record associated with the user that can include identification information and security information allowing the authentication of the user and subsequent access to the user's account on the cloud services.

When a user wishes to deposit fiat currency into the financial institution, a series of transactions can be initiated. The user can access computer readable instructions on a remote computer device (“app”) at 304 from a remote device such as smart phone 118 (FIG. 1) through a wired, wireless, or global network to access the cloud service at 306. The cloud service can receive the deposit request at 308 and transmit to the app a unique reference number associated with and unique to that user and specific transaction. When the deposit is made at 310 by providing fiat currency to the financial institution, the unique reference number can be associated with the physical deposit such as with the memo field of the transaction at the financial institution. The cloud service can then associate the deposit with the user a credit the user's account at the cloud service with the deposit amount at the financial institution at 312. The reference number can be time expired. A transaction fee can be charged to the user, shared with the financial institution, a service operator or any combination.

Further, the cloud service can interact with third parties 126 (FIG. 1) using mobile phones, service operators and the like on a worldwide basis to take in physical fiat value at their location. For example, when a user is purchasing a good or services, the vendor of these goods or services (e.g. service operators) can receive fiat currency for the associated goods or services. The service operators can have their account at the financial institution credited. Further, the user can also deposit fiat currency into the user's accounts through the service operators. The user can receive digital currency at the cloud service through the service operators nearly instantly which can result in lower fees while allowing the service operator to compensation, attract a customer and increase physical impression.

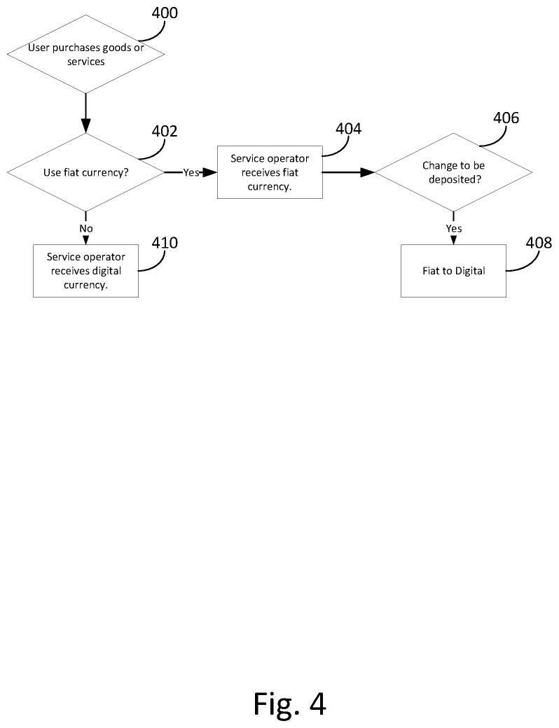

Referring to FIG. 4, if a user wishes to purchase goods or services at 400, the user can receive the goods or services. The determination can be made if the user wishes to provide compensation for the goods or services at 402 with digital currency or fiat currency. If fiat currency is to be used, the user provides the fiat currency to the service operator at 404. A determination can be made at 406 to convert change from the fiat transaction or deposit fiat currency for deposit to digital currency at 406. If so, the fiat currency is accepted by the service operator, the account of the service operator is debited on the cloud server and the user account on the cloud server is credited at 408. If digital currency is to be used, the user account at the cloud service is debited and the service operator's account at the cloud service is credited at 410. Therefore, the user is provided with increased convenience for transactions with the ability to conduct a commercial transaction with fiat currency, digital currency, credit the user's digital count with fiat currency or any combination at the service operators location without having to necessarily visit a financial institution.

When the user is at the financial institution or service operator, the user can present a deposit card or screen, virtual or physical, that can include the financial institution account or service operator account for deposit, with the reference number and other instructions. If the user is using an app, the app can retrieve and record the physical location and date and time stamp when the deposit is made for further reference, verification, identification, and security including Know Your Customer (KYC) details and specifics to reduce or minimize the risk of mistaken or fraudulent transactions.

Referring to FIG. 1, the cloud service and its associated immutable processes 112 can then convert the fiat currency into digital currency such as cryptocurrency and credit the user; account with the proper amount. The cloud service can use a house account maintained on the cloud service or credit an existing wallet associated with the user. Given the pre-existence of the financial institution account, services operator account and the cloud service relationship the speed of conversion of fiat currency to blockchain currency can be significantly improved.

The cloud service can also be in communications with an Immutable ATM or Immutable ATM network 120 (FIG. 1). An Immutable ATM can be a movable housing such as a kiosk or immovable housing such as integrated into a physical structure (e.g. building). The Immutable ATM can be located at the financial institutions, a service operator, on a mobile platform (e.g. vehicle), a stand-alone location or any combination. Referring to FIG. 3, the Immutable ATM 236 can be in communications with a financial institution 232, the cloud service 238 or both allowing electronic communications between the ATM, financial institution, cloud service or any combination.

Referring FIG. 1, the user can deposit fiat currency into a physical banking network 120 such as the Immutable ATM, a physical financial institution branch, wire transfer, ACH transaction, or any combination. The fiat currency can also be deposited (or withdrawn) with the app or an identifying article (e.g. magnetic strip card) 130. The physical banking network can receive the information and fiat currency and transmit to the cloud service that the deposit was made. A service operator can be in communications with the physical banking network to also allow a deposit, withdrawal and transaction information to be sent to the cloud services.

The currency can be placed in the financial institution associated with the physical banking network, in the account known to the cloud service, and the user's account on the cloud service appropriately credited. The deposit can be converted to digital currency and the account, such as a digital wallet of the user, can be appropriately credited. A transaction fee can be assessed against the physical banking network owner, financial institution, Immutable ATM or any combination. The Blockchain ATM can also be used to retrieve fiat currency from the user's digital account to debit the digital currency amount thereby allowing the conversion of digital currency to fiat currency.

The app can also include an Immutable ATM function where checks or other non-cash fiat currency can be deposited to the financial institution and the user account credited. For example, the user can receive a currency representation such as a check, notes, and the like. Using these currency representations, the app can be in wireless communications with the Immutable ATM, financial institution or service operator to communicate deposits, withdrawals, transactions and the like.

A producer or transaction processor, also described as a miner, 122 can be associated with the platform 132 for the purpose of providing liquidity to the platform. A miner can add debit, credit, sales, purchase, and other transactions to a immutable ledger such as blockchain and can be rewarded with digital currency. This digital currency can then be circulated among the platform and used by the financial institutions, account user and holders, service operators and vendors. These miners can also serve as transaction verification sources.

Computer readable instructions can provide the structure and function and facilitate agreements and transactions between the cloud service and the producer to automatically debit and credit their digital wallets that can be used for liquidity and that can help fulfill the demands of the users, consumers and merchants. The producer can be rewarded with a fee from providing the liquidity based on micro-time loans sometime in the time span of seconds versus traditional monthly or annually calculations. The inclusion of the producers provides a source for digital loans and provide digital currency liquidity

Digital currency, as other currencies, in and of itself has little utility absent the ability for it to be used for transactions for goods or services. There are retailers, wholesalers, and service providers, collectively referred to as Merchants, that are adopting digital currencies in increasing numbers. The adoption is partly based on the low transaction costs for blockchain currency transactions (e.g. 0.3% compared with 3.5%). Examples include very low transactions fees that can be $0.01 to $0.03 per transaction. Further, the server can include immediate or near immediate batch close for cybercurrency transactions and also provide immediate or near immediate conversions between cryptocurrency to fiat currency.

Referring to FIG. 1, Merchants can have point of sale systems 124 that can be in communications with the cloud service and transmit transactional information between the cloud service and the Merchant. Further, the cloud service can facilitate direct services 128. such as transaction verification for real estate, contracts, and business services, transactions, contracts, agreements and the like. These Merchants can use immutable services provided by third parties, be paid directly from fiat currency and also be accessibly through the app. The Merchants can provide their goods and services and transactions accomplished with graphical user interface (GUI) 114 such as local software, SaaS or other interaction in communications with the vendors systems and the cloud service.

The cloud service, by facilitating these transactions, can charge a transaction fee for such service. A goods or services request and the accompanying deliverables can be performed through the app that can be in communications with one or more vendor or service provider systems. A goods or services request and the accompanying deliverables can be performed through the app in communications with one or more vendor or service provider systems.

The fees described herein can be substantially lower than traditional financial fees based upon the structure, arrangement and functional of the system.

Computer readable instructions, when executed by a computer processor, cause the computer to perform a series of steps to accomplish a specific task and results in useful, concrete and tangible results. These computer readable instructions can be tied to a particular machine or apparatus with the specific purpose of executing the computer readable code for accomplishing tangible results and represents and accomplishes the manipulation of physical data.

The description herein be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result when executed by a computer and its processor representing or resulting in the tangible manipulation of physical objects. These steps also require physical manipulations of physical quantities such as electrical or magnetic physical elements and are capable of being stored, transferred, combined, compared, or otherwise manipulated readable medium that is designed to perform a specific task or tasks. Actual computer or executable code or computer readable code may not be contained within one file or one storage medium but may span several computers or storage mediums. The term “host” and “cloud service” may be hardware, software, or combination of hardware and software that provides the functionality described herein.

The present invention is described below with reference to flowchart and schematic illustrations of methods, apparatus (“systems”) and computer program products according to the invention. It will be understood that each block of a flowchart illustration can be implemented by a set of computer readable instructions.

Is should be noted that the app can cloud server can be configured and cooperatively arranged to provide the functionality described herein.

Elements of the flowcharts and schematics support combinations of ways for performing the special functions, combinations of steps for performing the specified functions and program instruction means for performing the specified functions. It will be understood that each block of the flowchart illustrations can be implemented by special purpose hardware-based computer systems that perform the specified functions, steps, or combinations of special purpose hardware or computer instructions.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A currency agnostic conversion and deployment system comprising:
a remote computer device having a set of remote computer readable instructions;
an immutable digital ledger; and,
a cloud service in communications with the remote computer device and the immutable digital ledger and having a set of cloud service computer readable instructions that, when executed by one or more processors, provide for:
receiving a fiat currency deposit request from the remote computer device,
creating a unique reference number associated with the fiat currency deposit request,
capturing a location, date and time of the remote computer device,
associating the fiat currency deposit request with an account holder associated with the remote computer device, and,
crediting a cloud service user account with a value represented by the fiat currency deposit request,
storing the fiat currency deposit request, the unique reference number, the location, date and time of the remote computer device, a cloud service user account credit on the immutable digital ledger,
transmitting to the remote computer device a confirmation representing that the cloud service user account was credited, and,
receiving digital currency from a producer
crediting a produce account on the cloud service associated with the producer; and,
an Immutable ATM in communications with the cloud service having computer readable ATM instructions for:
receiving fiat currency and transmitting the fiat currency deposit request to the cloud service,
receiving a fiat currency withdrawal request, ejecting fiat currency, and debiting the cloud service user account according to the fiat currency withdrawal request, and,
receiving a digital currency withdrawal request, receiving a digital currency card, recording a digital currency value on the digital currency card, ejecting the digital currency card, and debiting the cloud service user account according to the digital currency withdrawal request;
a service operator computer device is communications with the cloud service and having service operator computer readable instructions for:
receiving the fiat currency and transmitting the fiat currency deposit request to the cloud service,
receiving the fiat currency withdrawal request and debiting the cloud service user account according to the fiat currency withdrawal request, and,
receiving a digital purchase request, debiting the cloud service user account according to the digital purchase request, and crediting a service operator cloud service account according to the digital purchase request.

2. The currency agnostic conversion and deployment system of claim 1 wherein the service operator computer readable instructions include instructions for receiving a plurality of digital purchase requests, storing the plurality of digital purchase requests and crediting a service operator cloud service account according to the plurality of digital purchase requests.

3. The currency agnostic conversion and deployment system of claim 1 wherein the remote computer device is a financial institution computer device.

4. The currency agnostic conversion and deployment system of claim 1 wherein the remote computer device is a merchant point of sale system.

5. The currency agnostic conversion and deployment system of claim 1 wherein the remote computer device is a smart phone.

6. The currency agnostic conversion and deployment system of claim 5 wherein the smart phone is configured to capture an image of the fiat currency deposit request and transmit the fiat currency deposit request to the cloud service.

7. The currency agnostic conversion and deployment system of claim 6 wherein the fiat currency deposit request is an instrument directing a financial institution to pay a specific sum of money to the account holder associated with the remote computer device.

8. The currency agnostic conversion and deployment system of claim 1 wherein the cloud service is communications with a plurality of financial institution computer devices.

9. A currency agnostic conversion and deployment system comprising:
an immutable digital ledger; and,
a cloud service in communications with a financial computer device and the immutable digital ledger and having a set of cloud service computer readable instructions that, when executed by one or more processors, provide for:
receiving a fiat currency deposit request from the financial computer device,
creating a unique reference number associated with the fiat currency deposit request,
capturing a location, date and time of the financial computer device,
associating the fiat currency deposit request with an account holder associated with the financial computer device, and,
crediting a cloud service user account with a value represented by the fiat currency deposit request,
storing the fiat currency deposit request, the unique reference number, the location, date and time of the financial computer device, a cloud service user account credit on the immutable digital ledger,
transmitting to the financial computer device a confirmation representing that the cloud service user account was credited, and,
a service operator computer device is communications with the cloud service and having service operator computer readable instructions for receiving a fiat currency withdrawal request and transmitting the fiat currency withdrawal request to the cloud service.

10. The currency agnostic conversion and deployment system of claim 9 wherein the set of cloud service computer readable instructions include instructions for receiving digital currency from a producer and crediting a produce account on the cloud service associated with the producer.

11. The currency agnostic conversion and deployment system of claim 9 including an Immutable ATM in communications with the cloud service having computer readable ATM instructions for receiving fiat currency deposit request and transmitting the fiat currency deposit request to the cloud service and receiving a fiat currency withdrawal request, ejecting fiat currency, and debiting the cloud service user account according to the fiat currency withdrawal request.

12. The currency agnostic conversion and deployment system of claim 11 wherein the set of cloud service computer readable instructions include instructions for crediting a financial institution account in a percentage of a value of the fiat currency deposit request.

13. The currency agnostic conversion and deployment system of claim 11 wherein the computer readable ATM instructions include instruction for receiving a digital currency withdrawal request, receiving a digital currency card, recording a digital currency value on the digital currency card, ejecting the digital currency card, and debiting the cloud service user account according to the digital currency withdrawal request.

14. A currency agnostic conversion and deployment system comprising:
an immutable digital ledger; and,
a cloud service in communications with a financial computer device and the immutable digital ledger and having a set of cloud service computer readable instructions that, when executed by one or more processors, provide for:
receiving a fiat currency deposit request from a remote computer device in communications with the cloud service,
associating the fiat currency deposit request with an account holder associated with the remote computer device, and,
crediting a cloud service user account with a value represented by the fiat currency deposit request,
storing the fiat currency deposit request, a location, date and time of the financial computer device, a cloud service user account credit on the immutable digital ledger,
transmitting to the remote computer device a confirmation representing that the cloud service user account was credited, and,
receiving a digital purchase request, debiting the cloud service user account according to the digital purchase request, and crediting a service operator cloud service account according to the digital purchase request.

15. The currency agnostic conversion and deployment system of claim 11 wherein the set of cloud service computer readable instructions include instructions for receiving the fiat currency withdrawal request and debiting the cloud service user account according to the fiat currency withdrawal request.

16. The currency agnostic conversion and deployment system of claim 15 wherein the financial computer device is an Immutable ATM.

17. The currency agnostic conversion and deployment system of claim 15 wherein the set of cloud service computer readable instructions includes instructions for receiving a digital transaction request, crediting a seller cloud service user account, and, debiting a buyer cloud service user account.

18. The currency agnostic conversion and deployment system of claim 17 wherein the set of cloud service computer readable instructions include instructions for crediting a financial institution account in a percentage of a value represented by the digital transaction request.

19. receiving a digital transaction request, crediting a seller financial institution account, and, debiting a buyer cloud service user account.

20. The currency agnostic conversion and deployment system of claim 15 wherein the set of cloud service computer readable instructions includes instructions for receiving a digital transaction request, crediting a seller cloud service user account, and, debiting a buyer financial institution user account.
